(19) United States
(12) Patent Application Publication
(10) Pub. No.: US 2008/0304690 A1
(43) Pub. Date: Dec. 11, 2008

(54) MOUTH SHIELD FOR MICROPHONES

(76) Inventor: Harold Timothy Poindexter, Naples, FL (US)

Correspondence Address: EDWARD M. LIVINGSTON, PA, 963 TRAIL TERRACE DRIVE, NAPLES, FL, 34103, US

(21) Appl. No.: 11/760,958

(22) Filed: Jun. 11, 2007

(51) Int. Cl. H04R 25/00

(52) U.S. Cl. 381/375

(57) ABSTRACT

A mouth shield (1) for a microphone headset (4) having a rigid arcuate frame which is attachable to the mouth piece holder (3) of a microphone headset (4) by clasping means (13, 15) so it may be removably attached as desired. The shield (1) has at least one air vent aperture (2) for ease of breathing and proximal audibility. An optional removable foam insert (14) may be adhesively attached to an inner side of the shield (4) to catch saliva while speaking. The shield (1) precludes external visibility of lips while speaking and interference with audibility caused by wind and other adverse weather conditions.

### BACKGROUND OF THE INVENTION

This invention relates to microphone headsets and more particularly to a mouth shield to limit external visibility of the lips during speaking and interference from wind and adverse weather conditions.

Microphone headsets are widely used for communication between individuals, particularly in sports. For instance, in football, coaches commonly transmit plays to the quarterbacks and communicate with their assistants. Unfortunately, one problem with the current microphone headsets is that a speaker's lips are visible and thus can be read by others, including the opposing team. Another problem with the microphone headsets is interference with audibility of transmission due to adverse weather conditions. For instance, wind adversely affects audibility and the listener may not hear a transmission. Also, rain, especially if heavy, can hit a microphone headset mouthpiece adversely affecting audibility and even damaging the mouthpiece.

Thus, a need exists for a microphone shielding device to shield the mouth from external visibility and adverse weather conditions.

The prior art includes the following references:

| Patent No. | | |
|---|---|---|
| (U.S. unless stated otherwise) | Inventor | Issue/Publication Date |
| 6,185,529 B1 | Chen et al | Feb. 06, 2001 |
| 6,997,178 B1 | Reynaud | Feb. 14, 2006 |
| 4,524,465 | Huber | Jun. 25, 1985 |
| 6,510,311 B1 | Stitt | Jan. 21, 2003 |
| 4,537,276 | Confer | Aug. 27, 1985 |
| 2002/0166557 A1 | Cooper | Nov. 14, 2002 |
| 4,374,301 | Frieder, Jr. | Feb. 15, 1983 |
| 2,376,871 | Fink | May 29, 1945 |

None of the above prior art provides a mouth shielding device for headset microphones which is removably attachable to a microphone headset as does the present invention.

### SUMMARY OF THE INVENTION

The primary object of the present invention is to provide a device that shields the mouth from external visibility to prevent third parties from reading one's lips while talking into the mouthpiece of a microphone headset.

Another object of the present invention is to shield the microphone mouthpiece from adverse weather conditions, particularly wind and rain so as to increase audibility of transmissions and decrease damage to microphones.

A further object of the present invention is to provide such a shield that is easily removable and attachable to a microphone headset.

An even further object of the present invention is to provide such a shield that is reusable.

The present invention fulfills the above and other objects by providing a mouth shield for a microphone headset with a rigid frame of sufficient size having an arcuate shape to shield the mouth from external visibility and interference from adverse weather conditions. The shield may be removably attachable to a microphone holder by a clasp or clamp. The shield has air vent apertures in the lower front half of the shield so that a user may breathe easier and still speak and be audible to someone proximate to him or her. A foam insert may be secured to an inner side of the shield and can be removably attachable by adhesive to protect the shield from spittle while one is speaking.

The above and other objects, features and advantages of the present invention should become even more readily apparent to those skilled in the art upon reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective view showing the mouth shield of the present invention attached to the microphone headset in use;

FIG. 2 is a frontal or outer view of the mouth shield of the present invention;

FIG. 3 is backside or inner side view of the mouth shield attached to a microphone mouthpiece of a headset;

FIG. 4 is a top-cross sectional view along the line 4-4 of FIG. 2;

FIG. 5 is a side-cross sectional view of the present invention along line 5-5 of FIG. 2 showing a clasping clip and optional disposable foam inner liner; and

FIG. 6 is a side-cross sectional view of the present invention along line 5-5 of FIG. 2 showing an alternative clasping clamp of the invention.

### DESCRIPTION OF THE PREFERRED EMBODIMENTS

For the purposes of describing the embodiment, the terminology used in reference to the numbered components in the drawings is as follows:

| | |
|---|---|
| 1. | microphone mouth shield |
| 2. | vent aperture |
| 3. | microphone holder |
| 4. | headset |
| 5. | wearer |
| 6. | proximal end |
| 7. | distal end |
| 8. | shield top |
| 9. | shield bottom |
| 10. | shield outer side |
| 11. | shield inner side |
| 12. | microphone |
| 13. | shield clasp |
| 14. | foam insert |
| 15. | shield clamp |
| 16. | clamp screw |
| 17. | foam adhesive |
| 18. | clamp holder |

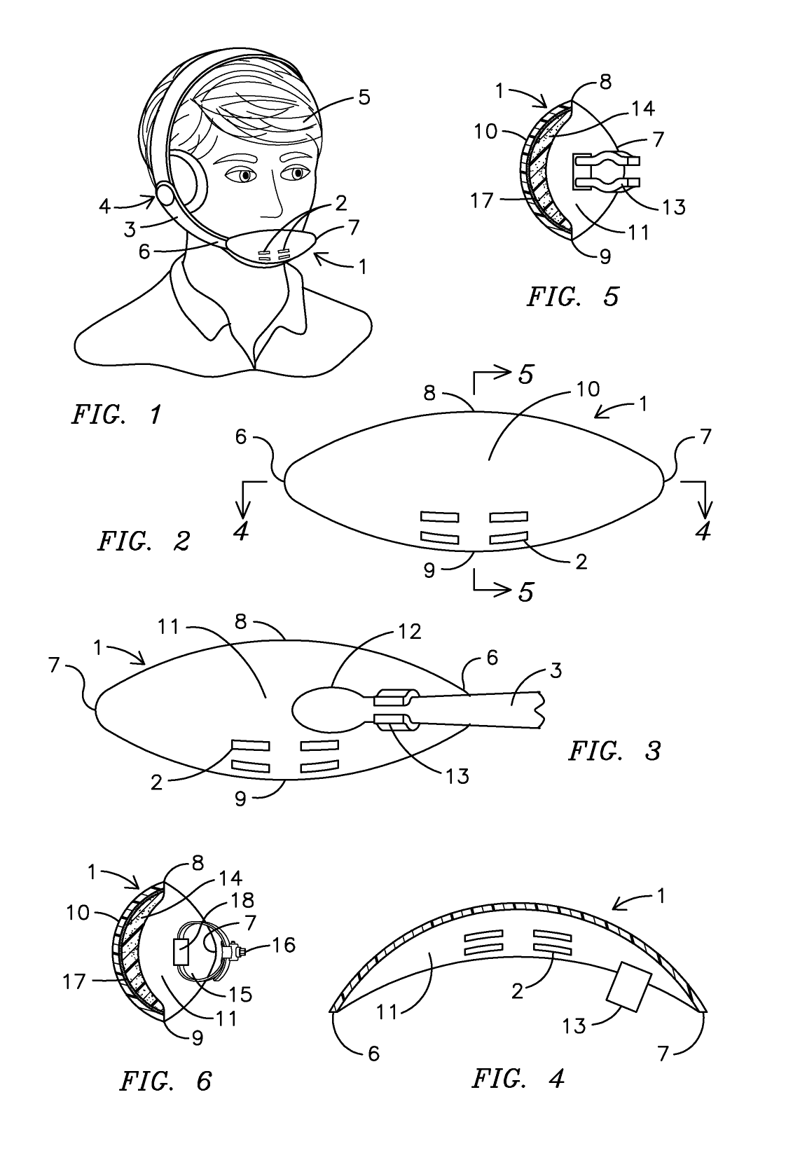

FIG. 1 shows the mouth shield 1 of the present invention attached to the microphone holder 3 of a headset 4 while being worn by a person 5. The mouth shield 1 preferably has a plurality of air vent apertures 2 in a lower side thereof to allow for easier breathing by the user and for increased audibility while speaking to those near the person 5. The mouth shield 1 is preferably attached to the microphone holder 3 at a proximal side 6. A distal side 7 curves around an opposite side of the mouth to preclude any external visibility of a person's lips. The shield preferably is made of a plastic or other rigid material.

FIG. 2 shows the front or outer side 10 of the mouth shield 1. The shield 1 would be arcuately shaped, substantially in the form of a semi-circle, as also shown in FIG. 4, in order to fully shield the user's mouth from external visibility. The shield has a top 8, bottom 9, a proximal side 6 and distal side 7. The shield 1 would preferably have one or more air vent holes 2 through a lower side in order to provide for ease of breathing and for audibility when the wearer is speaking to someone in close proximity.

FIG. 3 shows the back or inner side of the mouth shield 1. The mouth shield 1 is preferably attached over a microphone mouthpiece 12 by a clasp 3 so the shield 1 is removably attachable to a microphone holder 3.

The top-cross sectional view in FIG. 4 again shows a lower portion of the inner side 11 of mouth shield 1 showing the air vent apertures 2 and a portion of the clasp 13.

In FIG. 5, the side cross sectional view of the shield 1 shows a foam insert 14 which may be removably attachable by adhesive 17 to the inner side 11 of the mouth shield 1. The purpose of the foam 14 would be to catch any spittle or saliva while one is speaking so that it can be removed from the shield 1 and used again by another person so as to help avoid transmission of colds or other communicable diseases. The clasp 13 shown in FIG. 5 may comprise two opposing compressible flanges that would fit over the holder 3 of a microphone headset 4.

FIG. 6 shows essentially another cross-sectional view with a different clasp comprising a clamp 15 secured to a holder 18 on the inner side 11 of the mouth shield 1. The clamp 15 could be tightened or loosened by turning the screw 16 when it is on the microphone holder 3. This clasping means would enable the shield to fit a wide variety of sizes of microphone holders than would the clasp shown in FIG. 5.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A mouth shield for use with a microphone headset, said mouth shield comprising:
a rigid frame of sufficient size and shape to shield a wearer's mouth having an outer side, an inner side, a top, a bottom, and proximal and distal ends; and
a clasping means for attaching the frame to a mouthpiece holder on a microphone headset.

2. The mouth shield of claim 1 having at least one air vent aperture in the frame.

3. The mouth shield of claim 1 wherein a foam insert is secured to the inner side of the shield.

4. The mouth shield of claim 2 wherein a foam insert is secured to the inner side of the shield.

5. The mouth shield of claim 1 wherein the clasping means is located at the proximal end of the shield and comprises two opposing flanges extending perpendicularly from the inner side of the shield which snap around the mouth piece holder of the microphone headset.

6. The mouth shield of claim 1 wherein the clasping means is located at the proximal end of the shield and comprises an adjustably tightenable clamp attached to the inner side of the mouth shield.

7. The mouth shield of claim 2 wherein the clasping means is located at a proximal end of the shield and comprises two opposing flanges extending perpendicularly from the inner side of the shield which snap around the mouth piece holder of a microphone headset.

8. The mouth shield of claim 3 wherein the clasping means is located at the proximal end of the shield and comprises two opposing flanges extending perpendicularly from the inner side of the shield which snap around the mouth piece holder of the microphone headset.

9. The mouth shield of claim 4 wherein the clasping means is located at the proximal end of the shield and comprises two opposing flanges extended perpendicularly from the inner side of the shield which snap around the mouth piece holder of a microphone headset.

10. The mouth shield of claim 2 wherein the clasping means is located at the proximal end of the shield and comprises an adjustably tightenable clamp attached to the inner side of the shield.

11. The mouth shield of claim 3 wherein the clasping means is located at the proximal end of the shield and comprises an adjustably tightenable clamp attached to the inner side of the shield.

12. The mouth shield of claim 4 wherein the clasping means is located at the proximal end of the shield and comprises an adjustably tightenable clamp attached to the inner side of the shield.

13. The mouth shield of claim 1 having an arcuate shape extending outward from the top and bottom and proximal and distal ends to fully shield the wearer's mouth from external visibility.

14. The mouth shield of claim 3 wherein the foam insert is removably attachable to the inner side of the shield by an adhesive so it can be peeled off and replaced as desired.

15. The mouth shield of claim 4 wherein the foam insert is removably attachable to the inner side of the shield by an adhesive so it can be peeled off and replaced as desired.

16. A mouth shield for use with a microphone headset, said mouth shield comprising:
a rigid frame being of sufficient size and arcuately shaped to fully shield a mouth of the wearer having an outer side, an inner side, a top, a bottom, and proximal and distal ends;
a clasping means for attaching the frame to a microphone holder;
a foam insert on the inner side of the frame which is removably attachable by adhesive; and
at least one air vent aperture in the frame.
